(19) United States
(12) Patent Application Publication
(10) Pub. No.: US 2012/0086974 A1
(43) Pub. Date: Apr. 12, 2012

(54) IMAGE FORMING APPARATUS, PROCESSING METHOD OF THE IMAGE FORMING APPARATUS AND RECORDING MEDIUM

(75) Inventor: Yohei Kiuchi, Kawasaki-shi (JP)

(73) Assignee: CANON KABUSHIKI KAISHA, Tokyo (JP)

(21) Appl. No.: 13/224,177

(22) Filed: Sep. 1, 2011

(30) Foreign Application Priority Data
Oct. 8, 2010 (JP) 2010-229036

(51) Int. Cl. G06K 15/02

(52) U.S. Cl. 358/1.15

(57) ABSTRACT

In an image forming apparatus that registers objects designated in print jobs, whether the objects designated in the print jobs exist in the apparatus is determined. If it is determined that the objects do not exist in the apparatus, the print jobs are associated with identification information of the objects and stored as waiting jobs. When the objects are registered based on the identification information of the objects associated with the waiting jobs, printing of the stored waiting jobs starts.

### BACKGROUND OF THE INVENTION

1. Field of the Invention

The present invention relates to an image forming apparatus configured to be able to share resources designated in print jobs and a processing method of the image forming apparatus.

2. Description of the Related Art

Conventionally, there is a technique in which a document is divided into a fixed part and a variable part, and a merge print of supplying data of the variable part from a database, a CSV file, etc., is used to print content with small differences between pages in high volume. Printing using this technique is known as variable data printing (VDP).

An example of a document format technique for realizing the VDP includes PPML (Personalized Printing Markup Language) defined by PODi (Digital Print Initiative). The PPML is a language that is based on XML (eXtensible Markup Language) and that serves as standard specifications for describing a document by dividing the document into a fixed part and a variable part. RIP (Raster Image Processing) is applied to the fixed part and the variable part of the document, and the result after the RIP can be stored and reused.

The specifications of the PPML include an attribute called Scope for designating an effective section of the variable part. Possible values of Scope include Job and Document that are effective only in a section of part of a job, PPML that is effective within the same job, and Global that is effective across jobs. An object of the variable part in which Scope is Global is a resource that can be globally reused across jobs. Therefore, the object will be called a global reusable object. The resource does not have to be repeatedly transmitted for each job if the global reusable object is used, and the RIP does not have to be executed for each job. Therefore, there is an advantage that the throughput improves compared to when the resource in the apparatus is not used.

However, if the designated resource is not actually in the apparatus, the apparatus cannot print the job, and the job is cancelled. In this case, the operator has to register the resource in the apparatus and transmit the entire job to the apparatus again. This imposes a heavy load on the operator and causes a reduction in the throughput.

To handle the problem, for example, U.S. Pat. No. 7,672,010 discloses a technique of checking whether there is a missing resource before data transmission. Furthermore, a technique is disclosed, in which when a resource is missing before data transmission, the operator inputs an acquisition location of a resource to cause an apparatus that has received data to acquire the resource through a network.

However, the conventional techniques have a problem in that the job is canceled if the destination of the data cannot acquire the resource, and the entire job has to be inputted again to perform printing. In many cases, the VDP is mainly used in business form printing, etc., associated with a large amount of output. In that case, much time is required to re-input the entire job or to apply the RIP, and the throughput is significantly reduced.

The VDP printing system is huge, and the apparatus needs to interact with various applications. There is a demand for a technique for improving the throughput even under conditions in which the VDP applications do not sufficiently check the resources.

### SUMMARY OF THE INVENTION

The present invention provides an apparatus and a method for reducing the load of re-input by the operator and improving the throughput when an object designated in a print job is not in the apparatus.

According to one aspect of the present invention, there is provided an image forming apparatus that registers objects designated in print jobs, the apparatus comprising: a determination unit that determines whether the objects designated in the print jobs exist in the apparatus; a storage unit that associates the print jobs with identification information of the objects and stores the print jobs as waiting jobs if the determination unit determines that the objects do not exist in the apparatus; and a registration unit that registers the objects in the apparatus based on the identification information of the objects associated with the waiting jobs, wherein printing of the stored waiting jobs starts when the objects are registered.

Further features of the present invention will become apparent from the following description of exemplary embodiments (with reference to the attached drawings).

### BRIEF DESCRIPTION OF THE DRAWINGS

FIG. 1 is a diagram showing an example of a configuration of an image forming system according to the present embodiment.

FIG. 2 is a diagram showing a hardware configuration of an image forming apparatus.

FIG. 3 is a block diagram showing an example of configuration of a control unit (controller).

FIG. 4 is a diagram showing a configuration of an operation unit 210.

FIG. 5 is a diagram showing a configuration of a key input unit 402.

FIG. 6 is a diagram hierarchically showing a relationship between a print job, records, and pages.

FIG. 7 is a diagram showing an example of PPML data as a type of PDL data.

FIG. 8 is a diagram showing an example of PPML data as a type of PDL data.

FIG. 9 is a diagram showing a configuration of a mishit object management table 901.

FIG. 10 is a flow chart showing a printing process according to the present embodiment.

FIG. 11 is a flow chart showing a registration process of a global reusable object.

FIG. 12 is a diagram showing an example of an alternative object.

FIG. 13 is a diagram showing an example of a UI displayed on the operation unit 210.

FIG. 14 is a diagram showing an example of an outputted missing object list.

FIG. 15 is a diagram showing an example of outputted thumbnails.

FIG. 16 is a diagram showing an example of a UI displayed on the operation unit 210.

### DESCRIPTION OF THE EMBODIMENTS

Hereinafter, embodiments of the invention will be described in detail with reference to the drawings.

<Configuration of Image Forming System>

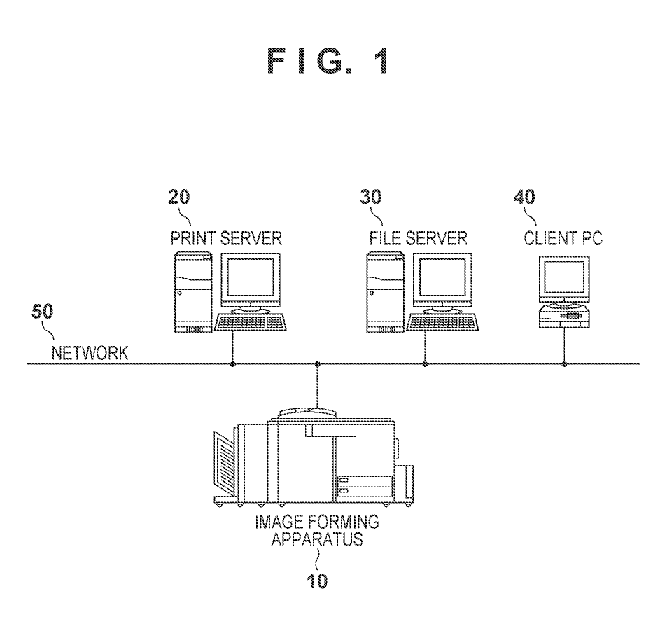

A configuration of an image forming system applicable to the present embodiment will be described. FIG. 1 is a diagram showing an example of the configuration of the image forming system according to the present embodiment. The image forming system includes at least an image forming apparatus 10, a print server 20, a file server 30, and a client PC 40. The image forming apparatus 10, the print server 20, the file server 30, and the client PC 40 are connected to be able to communicate with each other via a network 50, such as a LAN and a WAN.

The image forming apparatus 10 has various functions, such as scan, print, and copy. The print server 20 manages inputted print jobs and the image forming apparatus 10 connected via the network 50. The print server 20 can monitor the connected image forming apparatus 10 and the conditions of all print jobs and can control pause, setting change, printing restart of the print jobs, as well as copy, movement, and deletion of the jobs.

The file server 30 stores a customer database including customer data, such as destination, address, and name, as variable data used in variable printing. The client PC 40 has functions of editing application files and instructing printing. The client PC 40 has a function of assisting monitoring or controlling of the image forming apparatus 10 and the print jobs managed in the print server 20. The operator can use the client PC 40 to check the status, etc., of the print jobs.

<Configuration of Image Forming Apparatus 10>

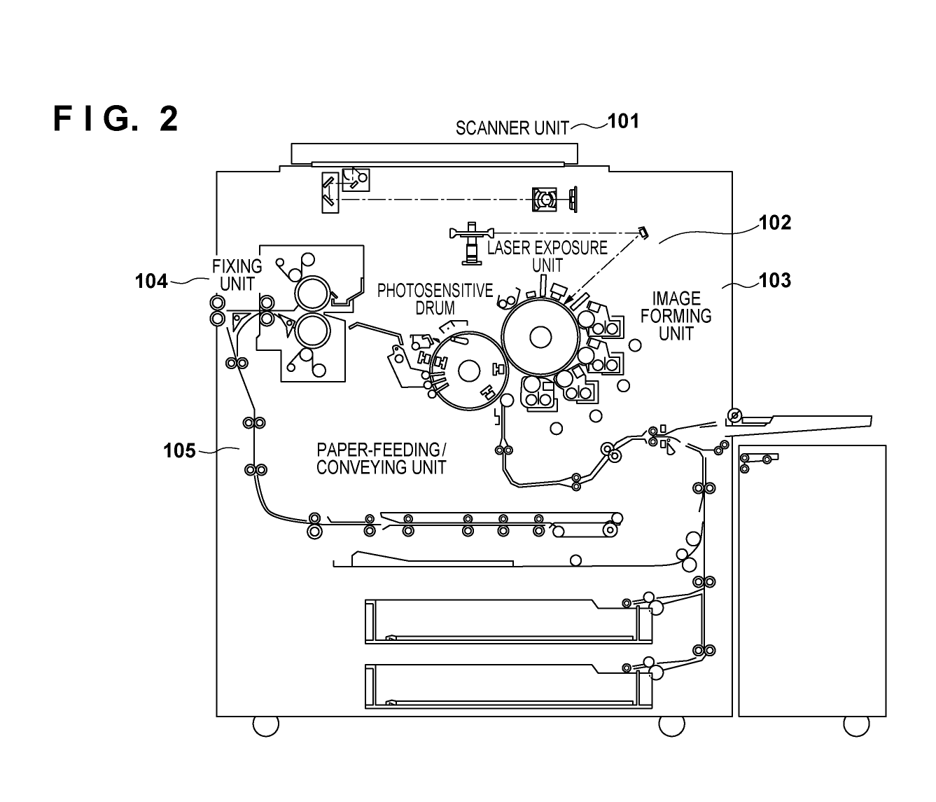

A hardware configuration of a multifunction peripheral (MFP) as an example of the image forming apparatus 10 will be described with reference to FIG. 2. As shown in FIG. 2, the MFP includes a scanner unit 101, a laser exposure unit 102, an image forming unit 103, a fixing unit 104, and a paper-feeding/conveying unit 105. A printer control unit not shown controls the components.

The scanner unit 101 illuminates light to a document placed on an original platen to optically read an original image and converts the image to an electric signal to create image data. The laser exposure unit 102 injects a light beam, such as a laser beam, modulated according to the image data into a rotating polygon mirror (polygonal mirror) that rotates at an equiangular speed to direct the light as reflected scanning light to a photosensitive drum.

The image forming unit 103 rotates and drives the photosensitive drum and charges the photosensitive drum by a charger. The image forming unit 103 uses toners to develop a latent image formed on the photosensitive drum by the laser exposure unit 102. Toner images are transferred to a sheet, and traces of toner left on the photosensitive drum without being transferred are collected. In the execution of the series of electrophotographic processes to form an image, development units (development stations) switch to sequentially repeat the electrophotographic processes while the sheet is wound around at a predetermined position of the transfer belt during four rotations. The development units include magenta (M), cyan (C), yellow (Y), and black (K) toners. After the four rotations, the sheet with a transferred full four-color toner image is separated from the transfer drum and conveyed to the fixing unit 104.

The fixing unit 104 is constituted by a combination of rollers and belts. The fixing unit 104 includes a heat source, such as a halogen heater, and heat and pressure dissolve and fix the toners on the sheet including the toner image transferred by the image forming unit 103.

The paper-feeding/conveying unit 105 includes one or more sheet storages represented by sheet cassettes and paper decks. The paper-feeding/conveying unit 105 separates a sheet from a plurality of sheets stored in the sheet storages according to an instruction of the printer control unit and conveys the sheet to the image forming unit 103 and the fixing unit 104. The sheet is wound around the transfer drum of the image forming unit 103 and conveyed to the fixing unit 104 after four rotations. The toner images of YMCK colors are transferred to the sheet during the four rotations. To form images on both sides of the sheet, the sheet passed through the fixing unit 104 is controlled to pass through a duplex conveyance path for conveying the sheet again to the image forming unit 103.

The printer control unit communicates with a control unit that controls the entire multifunction peripheral and controls the multifunction peripheral according to an instruction of the control unit. The printer control unit manages the conditions of the scanner unit 101, the laser exposure unit 102, the image forming unit 103, the fixing unit 104, and the paper-feeding/conveying unit 105 and issues instructions so that all components can harmoniously and smoothly operate.

<Configuration of Control Unit>

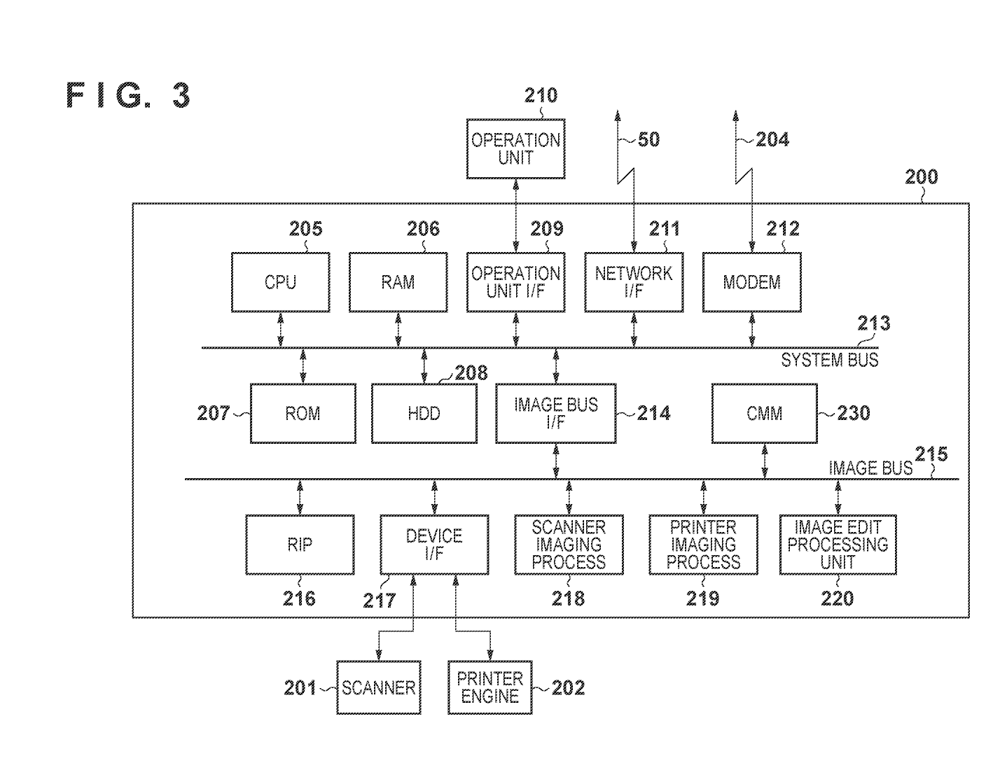

FIG. 3 is a block diagram showing an example of a configuration of the control unit (controller) in the image forming apparatus 10. A control unit 200 connects with a scanner 201 as an image input device and a printer engine 202 as an image output device to read image data and control print output. The control unit 200 is also a unit that connects with a LAN or public network 204 to input and output image information and device information via the network.

In the control unit 200, a CPU 205 is a central processing unit that controls the entire system. A RAM 206 is a system work memory for the operation of the CPU 205 and is an image memory for temporarily storing inputted image data. A ROM 207 is a boot ROM, and a boot program of the system is stored. An HDD 208 is a hard disk drive that stores system software for various processes, inputted image data, document data described later, etc.

An operation unit I/F 209 is an interface for an operation unit 210 that includes a display screen capable of displaying image data, etc. The operation unit I/F 209 outputs image data to the operation unit 210. The operation unit I/F 209 also transmits information inputted by the operator (i.e. user of multifunction peripheral) from the operation unit 210 to the CPU 205. A network I/F 211 is realized by, for example, a LAN card and is connected to a LAN 10 to input and output information to and from an external apparatus. A modem 212 connects with the public network 204 to input output information to and from an external apparatus. The devices are positioned on a system bus 213 of the control unit 200.

An image bus I/F 214 is an interface for connecting the system bus 213 and an image bus 215 described below and is a bus bridge that converts a data structure. The image bus 215 is a bus that transfers image data at a high speed and is constituted by a PCI bus or IEEE 1394. Devices, such as an RIP 216, a device I/F 217, a scanner imaging process 218, a printer imaging process 219, an image edit processing unit 220, and a CMM 230 described later, are connected to the image bus 215.

The RIP (raster image processor) 216 interprets a display list (DL) to create (render) a raster image and attribute information (attribute bit) corresponding to each pixel of the raster image. The device I/F 217 connects the scanner 201, the printer engine 202, and the control unit 200 to convert synchronous line/asynchronous line of image data.

The scanner imaging process 218 applies various processes, such as correction, processing, and edit, to inputted image data. The printer imaging process 219 applies processes, such as correction of printer and resolution conversion, to print output image data. The image edit processing unit 220 rotates image data and executes a compression/expansion process of image data and a variety of image processing based on the attribute bit generated by the RIP 216. The CMM (color management module) 230 is a dedicated hardware module that applies a color conversion process to image data based on a profile and calibration data.

The profile denotes information such as a function for converting color image data expressed by a color space dependent on a device into a color space (for example, Lab) independent from the device. The calibration data is data for correcting color reproduction characteristics of the scanner 201 and the printer engine 202.

<Configuration of Operation Unit 210>

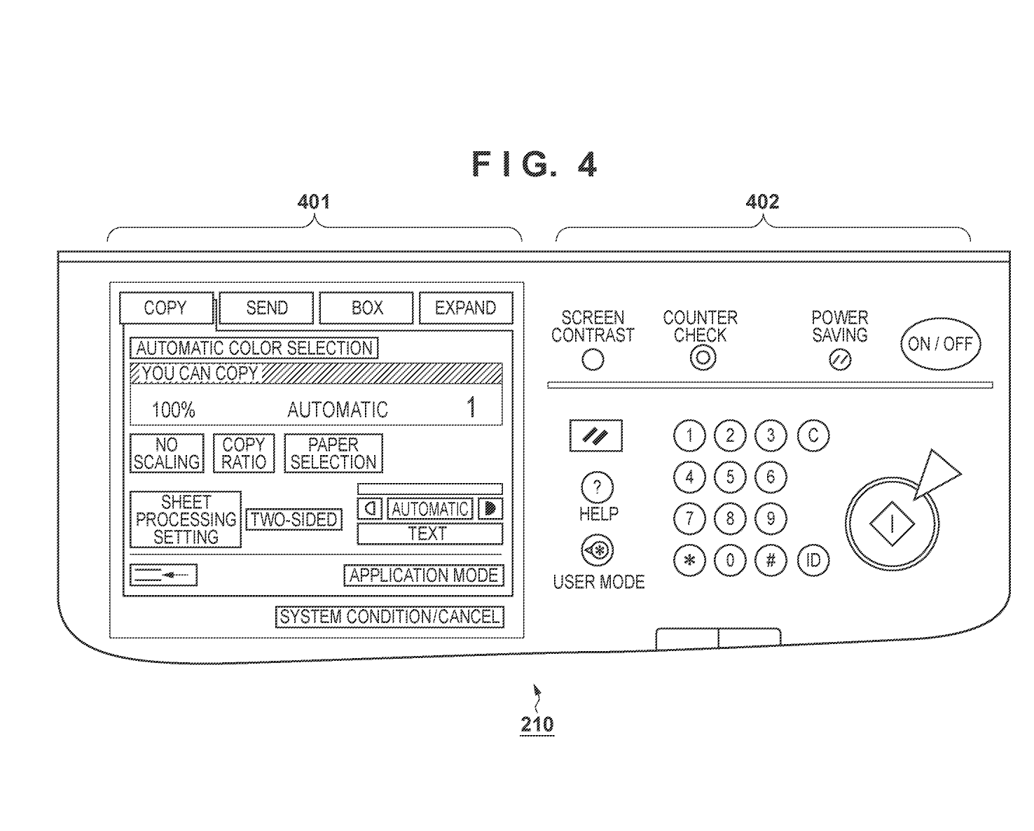

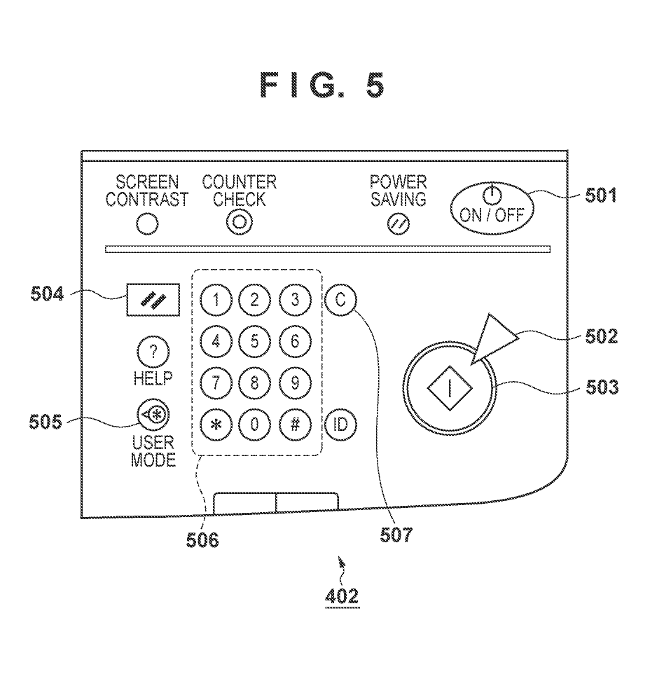

A configuration of the operation unit 210 in the image forming apparatus 10 will be described with reference to FIGS. 4 and 5. As shown in FIG. 4, the operation unit 210 includes a key input unit 402 that can receive a user operation by a hard key and a touch panel unit 401 as an example of a display unit that can receive a user operation by a soft key (display key).

The key input unit 402 includes an operation unit power supply switch 501 as shown in FIG. 5. The CPU 205 controls to selectively switch a standby mode and a sleep mode in response to a user operation of the operation unit power supply switch 501. The standby mode is a normal operation state, and a sleep mode is a state in which the consumed power is reduced by terminating a program in an interrupt waiting state in preparation for network printing or facsimile. The CPU 205 controls to allow receiving a user operation of the operation unit power supply switch 501 when a main power supply switch (not shown) for supplying power to the entire system is ON.

A start key 503 is a key that allows receiving, from the user, an instruction for causing a printing apparatus to start a process of a print job of a type instructed by the user, such as a copy operation and a transmission operation of a print job to be processed. A stop key 502 is a key that allows receiving, from the user, an instruction for causing the printing apparatus to suspend the process of the received print job.

A numeric keypad 506 is a key that allows the user to set input numerals of various settings. A clear key 507 is a key for cancelling various parameters, such as the input numerals set by the user through the numeric keypad 506. The reset key 504 is a key for invalidating all various settings set by the user for the print job to be processed and for receiving, from the user, an instruction for restoring the default setting values. A user mode key 505 is a key for shifting to a system setting screen of each user.

<Relationship between Print Job, Records, and Pages>

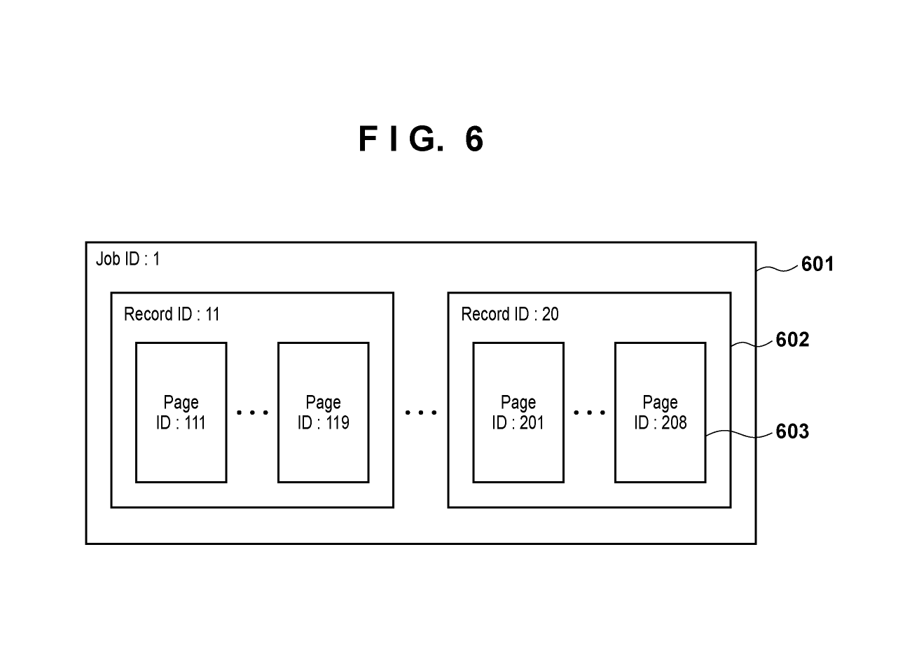

A relationship between a print job, records, and pages in the image forming apparatus 10 will be described with reference to FIG. 6 hierarchically showing the relationship. A print job 601 includes a plurality of records 602. Record information as a basis of the records 602 is stored in the file server 30.

Each record 602 includes one or more pages 603. The numbers of pages included in the records 602 do not have to be the same, and the numbers of pages may be different depending on the print content instructed by the records 602.

<Data to Be Processed by Image Forming Apparatus 10>

Data to be processed by the image forming apparatus 10 includes PDL data including a drawing command, etc., and a job ticket including a print setting, etc. Examples of the PDL include PPML and PDF/VT.

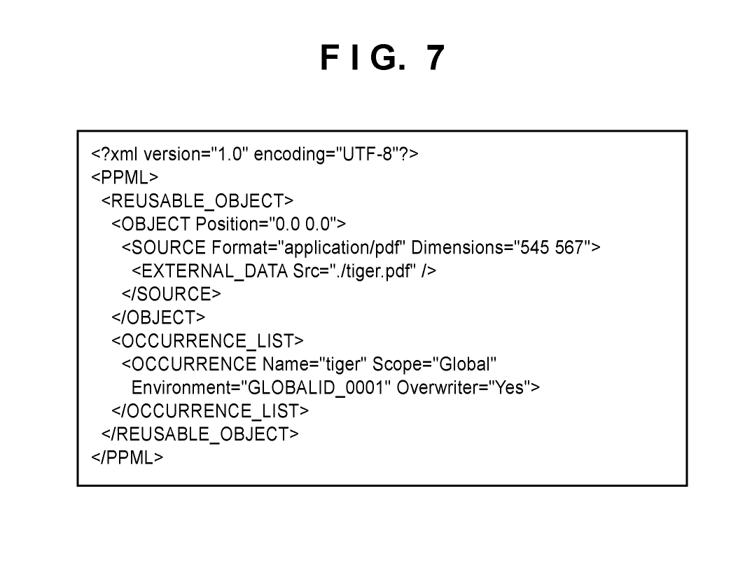

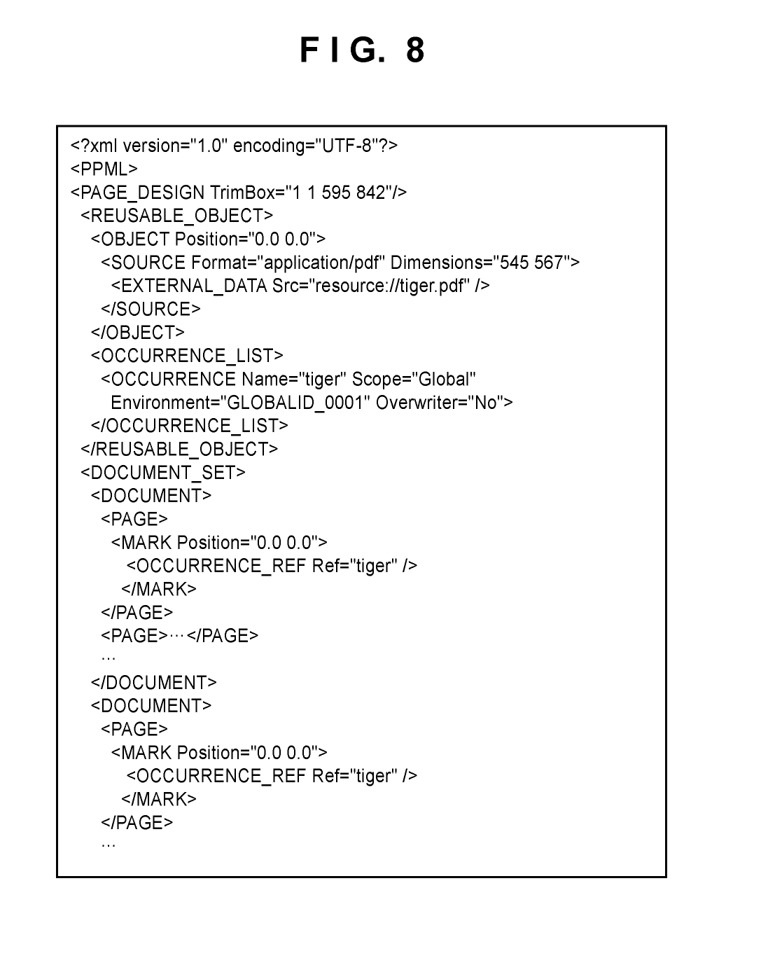

FIGS. 7 and 8 are excerpts showing examples of PPML data as a type of the PDL data. In the example shown in FIG. 7, “tiger.pdf” transmitted along with the PPML data is registered in the image forming apparatus 10 as a global reusable object including identification information “GLOBALID_0001”. In the example shown in FIG. 8, the global reusable object including the identification information “GLOBALID_0001” is extracted from the image forming apparatus 10 and is laid out in a predetermined page in the job. Details of the specifications of the PPML will not be described. It is obvious that the PDL data to be processed by the image forming apparatus 10 is not limited to the forms shown in FIGS. 7 and 8.

<Configuration of Mishit Object Management Table 901>

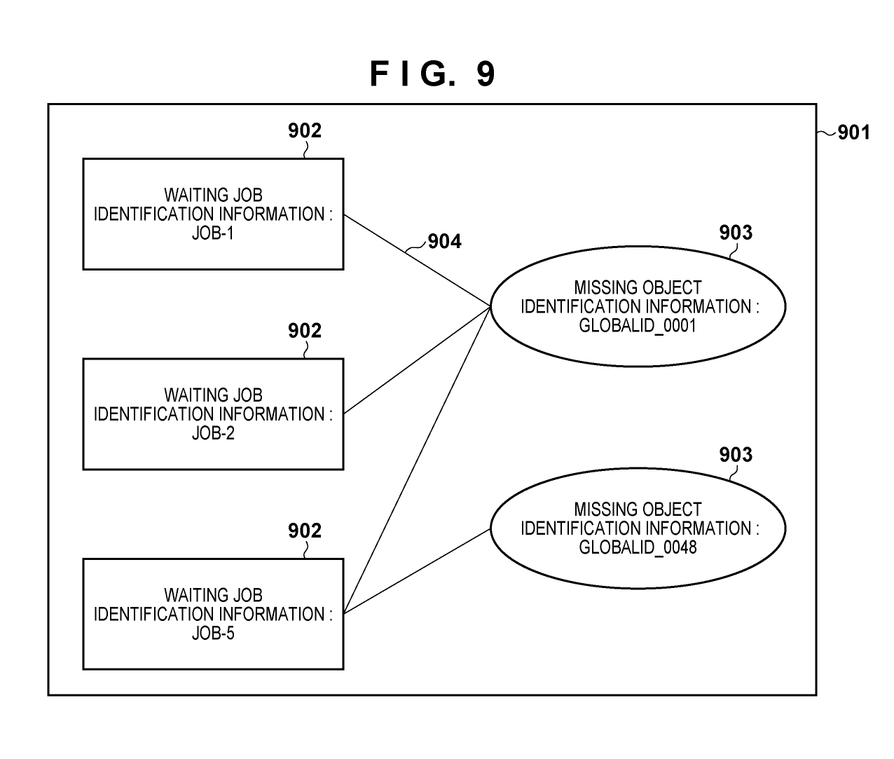

A configuration of the mishit object management table 901 held by the image forming apparatus 10 to manage an association between waiting jobs and missing objects will be described with reference to FIG. 9. Waiting jobs 902 and missing objects 903 are associated by an association 904 and held in the mishit object management table 901. More specifically, the association 904 associates the waiting jobs 902 with the missing objects 903, and the waiting jobs 902 can be printed when all the associated missing objects 903 are registered. In the example shown in FIG. 9, a waiting job JOB-1 is associated with only a missing object with object identification information “GLOBALID_0001”, and the waiting job JOB-1 can be printed when the object is registered.

<Printing Process>

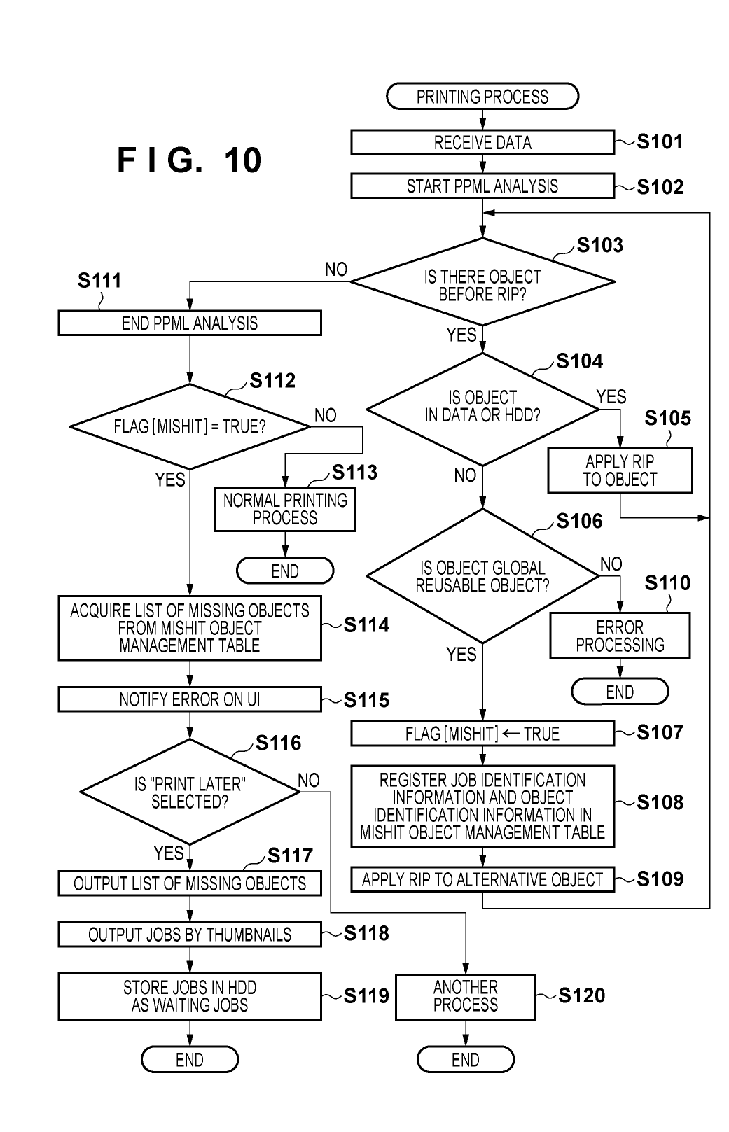

A printing process according to the present embodiment will be described with reference to FIG. 10. In S101, the CPU 205 receives, via the network I/F 211, a print job (PPML data) transmitted via the network 50 and stores the print job in the HDD 208. In S102, the CPU 205 starts analyzing the PPML data.

In S103, the CPU 205 determines whether there is an object before the RIP in the PPML data. If there is an object before the RIP in the PPML data, the process proceeds to S104. In S104, the CPU 205 determines whether the object before the RIP exists in the data or the HDD 208. If the object before the RIP exists in the data or the HDD 208, the process proceeds to S105, and the CPU 205 applies the RIP to the existing object before the RIP. The process returns to S103 when the process is finished, and the CPU 205 processes the remaining objects before the RIP.

If there is no object before the RIP in the data and the HDD 208 in S104, the object before the RIP is determined as a missing object, and the process proceeds to S106. In S106, the CPU 205 determines whether the missing object is a global reusable object. If the missing object is a global reusable object as a result of the determination, the process proceeds to S107. In S107, the CPU 205 sets a flag [mishit] to “TRUE”. The flag [mishit] is a flag indicating whether the print job refers to the global reusable object not in the data and the HDD 208 and is set to “FALSE” at the start of the printing process.

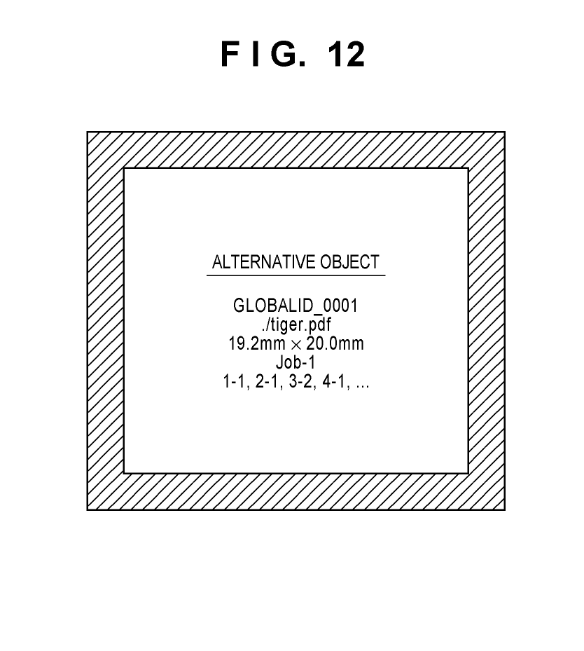

In S108, the CPU 205 associates the identification information of the print job with the identification information of the object and registers the information in the mishit object management table 901. In S109, the CPU 205 applies the RIP to an alternative object of the missing object. FIG. 12 shows an example of the alternative object. As shown in FIG. 12, information necessary for the operator to specify the missing object is embedded to the alternative object as hint information.

In the example, information, such as identification information, file name, size, job, record, and page of the missing object, is embedded to the alternative object as the hint information. As the hint information is embedded to the alternative object in the process, the operator can easily specify the missing object. The load of re-input by the operator is reduced, and the throughput can be improved. The alternative object is associated with the identification information of the missing object in a format identifiable by the CPU 205. The process returns to S103 when the RIP process is finished, and the remaining objects before the RIP are processed.

If the missing object is not a global reusable object in S106, the process proceeds to S110, and the CPU 205 executes error processing. The error processing includes notification of an error to the operator, an ending process of the print job, etc.

Instead of finishing the print job, a waiting state may be set to the print job to allow receiving an input of the missing job by the operator. The error processing is not important in describing the present invention, and the details will not be described. When the error processing is finished, the CPU 205 ends the process.

When the RIP of all objects is completed as a result of the process of S104 to S109, it is determined that there is no object before the RIP in the PPML data (“NO” in S103). The process proceeds to S111 to end the analysis of the PPML data. In S112, the CPU 205 determines whether the flag [mishit] is “TRUE”. If the flag [mishit] is not “TRUE” as a result of the determination, the process proceeds to S113, and the CPU 205 uses the printer engine 202 to execute a normal printing process. The printing process is not important in describing the present invention, and the details will not be described. When the printing process is finished, the CPU 205 ends the process.

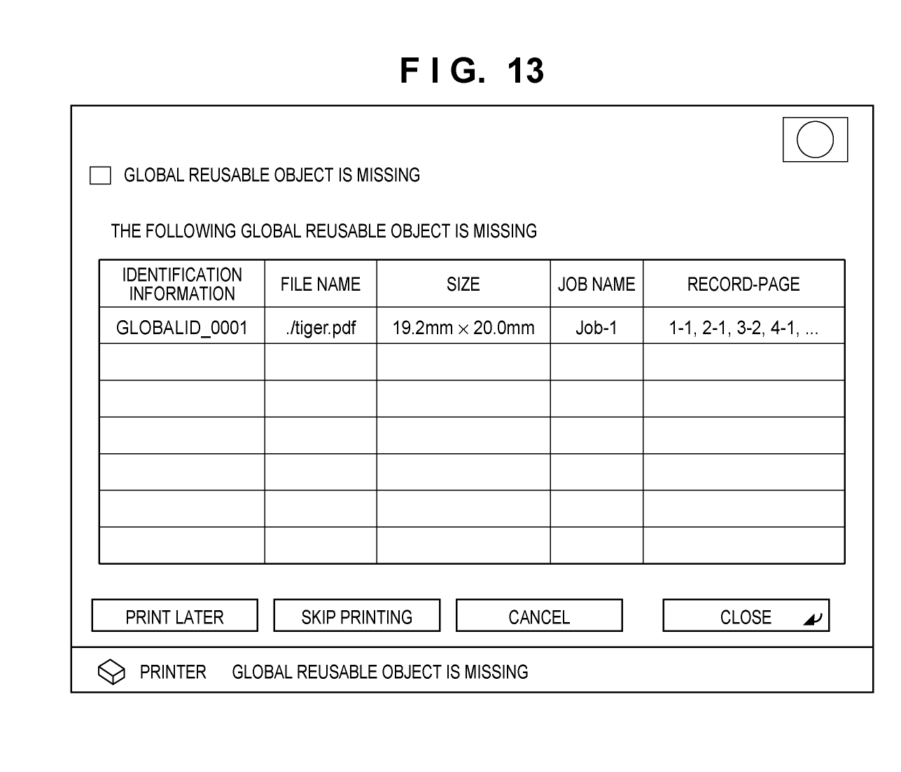

Meanwhile, if the flag [mishit] is “TRUE” in S112, the process proceeds to S114, and the CPU 205 acquires a list of the missing objects associated with the print job from the mishit object management table 901. In S115, the CPU 205 displays the content of the error on the operation unit 210 and prompts the operator to select a process. FIG. 13 shows an example of a UI displayed on the operation unit 210.

When the operator selects a process through the operation unit 210, the process proceeds to S116, and the CPU 205 determines whether the process selected by the operation is “Print Later”. If the process selected by the operator is “Print Later” as a result of the determination, the process proceeds to S117, and the CPU 205 uses the printer engine 202 to output a missing object list.

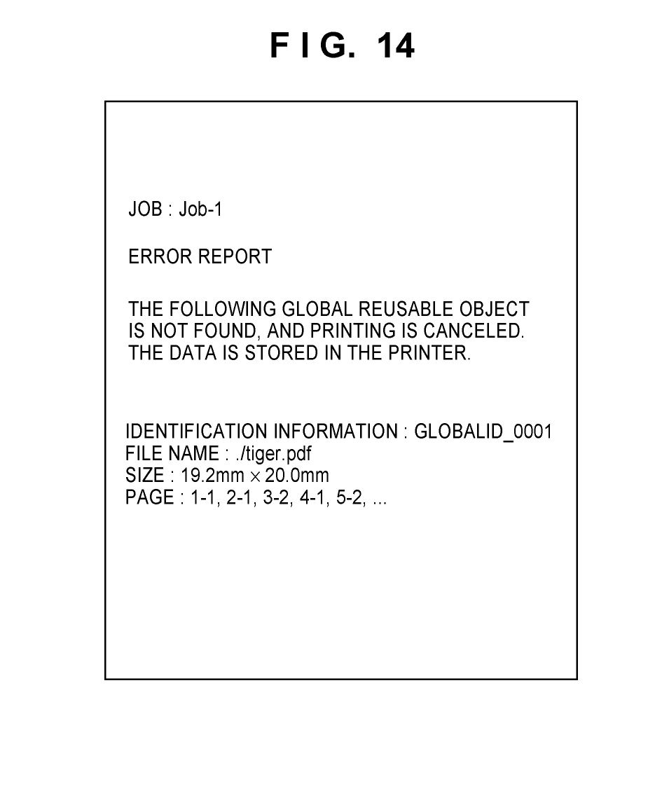

FIG. 14 shows an example of the outputted missing object list. As shown in FIG. 14, information necessary for the operator to specify the missing object is printed as hint information in the missing object list. In the present embodiment, the job, the identification information of the object, the file name, the size, the information of the record and the page, etc., are printed on the alternative object as the hint information. Printing of the hint information in the missing object list allows the operator to easily specify the missing object. The load of re-input by the operator is reduced, and the throughput can be improved.

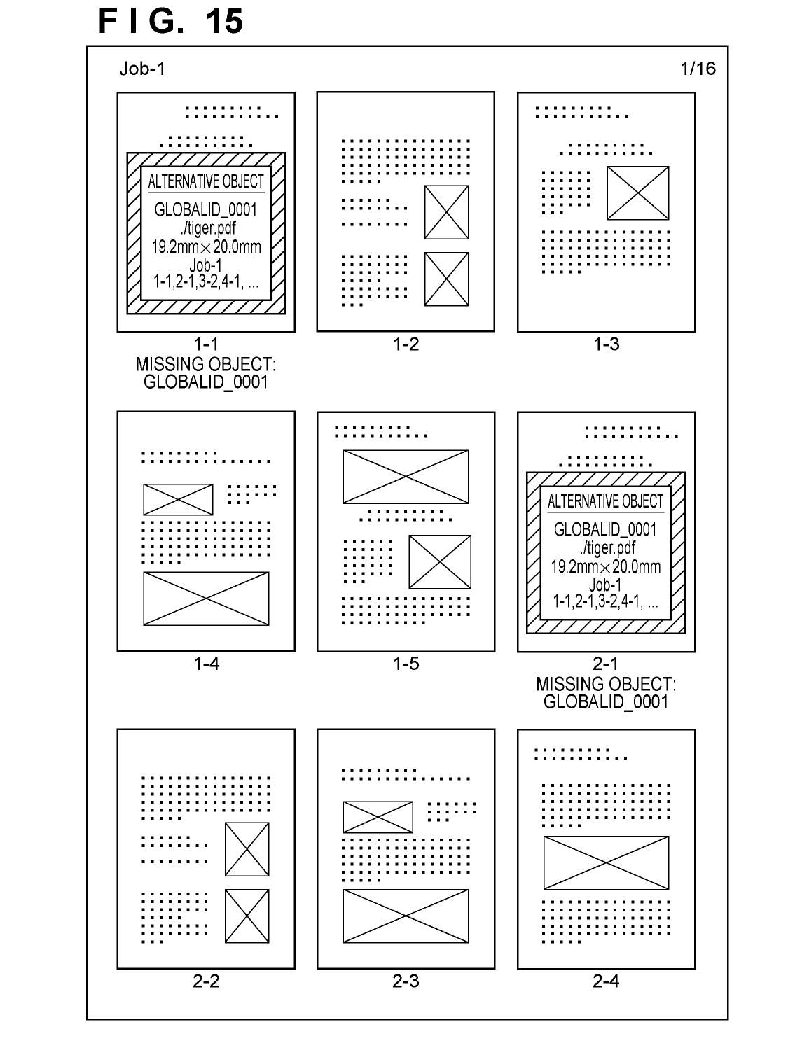

In S118, the CPU 205 uses the printer engine 202 to output thumbnails of the print jobs. FIG. 15 shows an example of the outputted thumbnails. As shown in FIG. 15, the alternative objects after the RIP in S109 are drawn in the thumbnails, in areas where the missing objects should be drawn. The output of the thumbnails allows the operator to easily specify the missing objects from the drawing areas of the alternative objects and the hint information embedded in the alternative objects. As a result, the load of re-input by the operator is reduced, and the throughput can be improved. In S119, the CPU 205 stores the print jobs in the HDD 208 as waiting jobs and ends the process.

If the process selected by the operator is not “Print Later” in S116, the process proceeds to S120, and the CPU 205 executes another process. Examples of the other process include a skip printing process of skipping the page or the record including the missing object to continue printing and a cancelling process of the print job. The other process is not important in describing the present invention, and the details will not be described. When the other process is finished, the CPU 205 ends the process.

If the resource designated in the print job is not in the data or the HDD 208 as a result of the process, the print job is stored in the HDD 208 as a waiting job. As a result, there is no need to re-input the entire print job when there is no designated resource in the apparatus, and printing can be started if only the missing resource is registered. Therefore, the load of re-input by the operator is reduced, and the throughput can be improved.

The existing resources are all stored in the HDD 208 after the RIP. As a result, the RIP process does not have to be applied to all of the jobs when the missing resource is registered, and printing can be quickly started by applying the RIP only to the resource. Therefore, the load of re-input by the operator can be reduced, and the throughput can be improved.

The hint information for assisting the operator to specify the missing object is displayed in the error notification, the missing object list, and the thumbnail that are outputted when the resource does not exist. The alternative object is drawn in the area of the thumbnail where the missing object should be drawn. This allows the operator to easily specify the missing object from the drawing area of the alternative object and the hint information embedded in the alternative object. The load of re-input by the operator can be reduced, and the throughput can be improved.

<Global Reusable Object Registration Process>

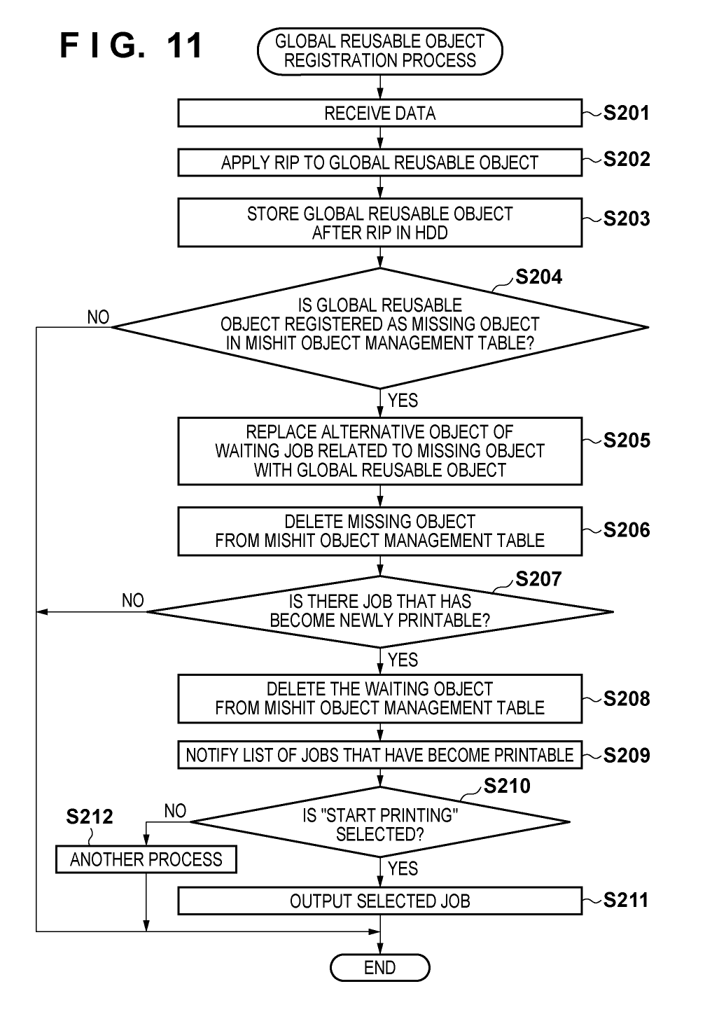

A registration process of the global reusable object according to the present embodiment will be described with reference to FIG. 11. In S201, the CPU 205 receives, via the network I/F 211, data transmitted via the network 50. In S202, the CPU 205 applies the RIP to the global reusable object included in the received data.

In S203, the CPU 205 stores the global reusable object in the HDD 208. The global reusable object is associated with object identification information designated in the data in a format identifiable by the CPU 205.

In S204, the CPU 205 determines whether the object is registered as a missing object in the mishit object management table 901. The process is a process of determining that the object is registered as a missing object if the object identification information of the newly registered global reusable object and the object identification information of the missing object match.

If the object is not registered as a missing object, the global reusable object registration process is finished. If the object is registered as a missing object, the process proceeds to S205. In S205, the CPU 205 sequentially develops the waiting jobs related to the missing object from the HDD 208 and replaces the alternative objects included in the waiting jobs with the newly registered global reusable objects.

In S206, the CPU 205 deletes the missing object from the mishit object management table 901. In S207, the CPU 205 determines whether there is a waiting job that has become newly printable. The process is a process of determining that the job has become newly printable if the waiting job registered in the mishit object management table 901 in S206 is not associated with any missing object.

If there is no waiting job that has become newly printable as a result of the determination, the global reusable object registration process is finished. On the other hand, if there is a waiting job that has become newly printable, the process proceeds to S208, and the CPU 205 deletes the waiting job that has become newly printable from the mishit object management table 901.

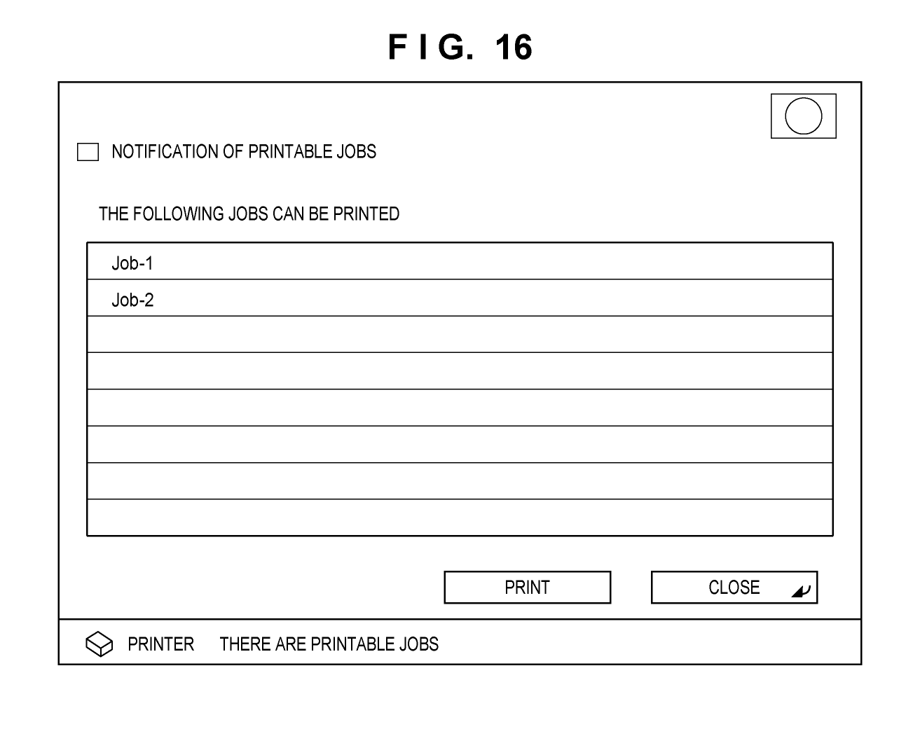

In S209, the CPU 205 notifies the operator of a list of the waiting jobs that have become printable. In this case, the CPU 205 displays the list of the waiting jobs that have become printable on the operation unit 210 and prompts the operator to select a process. FIG. 16 shows an example of a UI displayed on the operation unit 210. The notification of the list of the waiting jobs that have become printable is not limited to this, and for example, the list of the waiting jobs that have become printable may be printed and outputted.

When resources are registered in the image forming apparatus 10, the operator is notified of the list of the waiting jobs that have become newly printable among the waiting jobs stored in the HDD 208. As a result, the operator can easily recognize the waiting jobs that have become printable by the registration of the resources. The load of the operator at reprinting can be reduced, and the throughput can be improved.

When the operator selects a process through the operation unit 210 in S209, the process proceeds to S210, and the CPU 205 determines whether the process selected by the operator is “Start Printing”. If the process selected by the operator is “Start Printing”, the process proceeds to S211, and the CPU 205 uses the printer engine 202 to execute a printing process of the selected job. The printing process is not important in describing the present invention, and the details will not be described. When the printing process is finished, the CPU 205 ends the global reusable object registration process.

If the process selected by the operator is not “Start Printing” in S210, the process proceeds to S212, and the CPU 205 executes another process. The other process is not important in describing the present invention, and the details will not be described. When the other process is finished, the CPU 205 ends the global reusable object registration process.

As a result of the process, when the resources are registered in the image forming apparatus 10, the operator is notified of the list of the waiting jobs that have become newly printable among the waiting jobs stored in the HDD 208. As a result, the operator can easily recognize the waiting jobs that have become printable by the registration of the resources. The load of the operator at reprinting can be reduced, and the throughput can be improved.

The image forming apparatus 10 applies the RIP process only to the newly registered resources and starts printing by replacing the alternative objects in the print jobs stored in the HDD 208 with the resources. As a result, all of the print jobs do not have to be re-inputted, and printing can be started when the RIP process is applied only to the newly registered resources. Therefore, the load of re-input by the operator can be reduced, and the throughput can be improved.

Although the printing process and the global reusable object registration process are separately executed in the present embodiment, the present invention is not limited to this. For example, if the global reusable object is included in the PPML, the global reusable object registration process may be continuously executed. If the global reusable object is included in the PPML, the list of the jobs that have become newly printable can be notified after the printing process of the PPML data.

Although the list and the thumbnails of the missing objects are automatically outputted in the present embodiment, the list and the thumbnails of the missing objects may be outputted at an arbitrary timing based on an instruction by the operator.

According to the present embodiment, when a resource designated in a print job does not exist in the apparatus, the print job can be stored in the apparatus, and the print job and the identification information of the missing resource can be associated and managed. Therefore, when a resource designated in a print job does not exist in the apparatus, the entire print job does not have to be re-inputted, and the printing can be started when only the missing resource is inputted. As a result, the load of re-input by the operator can be reduced, and the throughput can be improved.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-229036, filed Oct. 8, 2010, which is hereby incorporated by reference herein in its entirety.

What is claimed is:

1. An image forming apparatus that registers objects designated in print jobs, the apparatus comprising:
a determination unit that determines whether the objects designated in the print jobs exist in the apparatus;
a storage unit that associates the print jobs with identification information of the objects and stores the print jobs as waiting jobs if said determination unit determines that the objects do not exist in the apparatus; and
a registration unit that registers the objects in the apparatus based on the identification information of the objects associated with the waiting jobs, wherein
printing of the stored waiting jobs starts when the objects are registered.

2. The apparatus according to claim 1, wherein
said determination unit outputs a list of the identification information of the objects determined not to exist in the apparatus.

3. The apparatus according to claim 1, further comprising
an output unit that outputs thumbnails of alternative data in areas of the waiting jobs where the objects, determined not to exist in the apparatus by said determination unit, should be drawn.

4. The apparatus according to claim 1, further comprising
a list output unit outputs a list of printable waiting jobs when the waiting jobs become printable.

5. A processing method of an image forming apparatus that registers objects designated in print jobs, the method comprising:
determining whether the objects designated in the print jobs exist in the apparatus;
associating the print jobs with identification information of the objects and storing the print jobs as waiting jobs if it is determined in said determining that the objects do not exist in the apparatus; and
registering the objects in the apparatus based on the identification information of the objects associated with the waiting jobs, wherein
printing of the stored waiting jobs starts when the objects are registered.

6. A computer-readable recording medium recording a program for causing a computer to execute the processing method of the image forming apparatus according to claim 5.
